(19) United States
(12) Patent Application Publication
(10) Pub. No.: US 2007/0043171 A1
(43) Pub. Date: Feb. 22, 2007

(54) Polymer composition comprising a rubber modified styrenic polymer resin and an ethylenic rubber polymer

(76) Inventors: Se Bum Son, Seoul (KR); Sung Hee Ahn, Seoul (KR); Dong Jin Kim, Gunpo-Si (KR); Jin Hwan Choi, Anyang-Si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/319,806

(22) Filed: Dec. 28, 2005

(30) Foreign Application Priority Data
Aug. 19, 2005 (KR) KR 2005-76229

(51) Int. Cl. C08F 8/00

(52) U.S. Cl. 525/191

(57) ABSTRACT

A polymer composition includes a rubber modified styrenic copolymer resin and an ethylenic rubber polymer that includes an acidic moiety. The composition can also include a styrenic polymer resin. Molded articles of the polymer composition have good impact strength and flowability.

### BACKGROUND OF THE INVENTION

1. Field of the Invention

The invention relates to polymer compositions a rubber-modified styrenic copolymer resin and an ethylenic rubber polymer resin comprising an acidic moiety. It further relates to molded articles of the polymer composition with good impact resistance and flowability.

2. Description of the Related Art

Generally, rubber-modified styrenic resins are widely used in the production of internal and external parts for electronic products and non-electronic products because of its good processability and mechanical strength. Increasingly, electronic products are rapidly becoming larger in size and thinner. The addition of flame retardants to these resins in large-size thin-film products generally decreases the impact resistance and rigidity of the resin. Accordingly, good flowability and impact resistance have become highly desired properties in these styrenic resins. However, current methods of using impact modifiers and controlling the particle size distribution in the resin have significant limitations.

### SUMMARY OF THE INVENTION

A polymer composition includes a rubber-modified styrenic copolymer resin; and an ethylenic rubber polymer resin comprising an acidic moiety. The acidic moiety can originate from a number of sources, including a polyfunctional acid or its derivatives, such as maleic acid or phthalic acid and their derivatives. The acidic moiety is preferably present from about 0.01 to about 3 part by weight, based on 100 parts by weight of the ethylenic rubber copolymer.

The ethylenic rubber polymer resin can be a copolymer of at least two ethylenic monomers, one of which can be a diene, such as 1,2-hexadiene, 1,4-hexadiene, butadiene, dicyclopentadiene, 5 ethylidene-2-norbornene, or a combinations thereof. The ethylenic rubber polymer can also be a polymer of ethylenepropylenediene monomers (EPDM), ethylenepropylene monomer (EPM), or copolymers thereof.

The rubber modified styrenic copolymer resin can also be a styrenic copolymer resin, which can be formed as an additional layer around the rubber modified styrenic copolymer resin. Examples of the rubber-modified stryenic copolymer resin include at least one selected from a group consisting of acrylonitrile-butadiene-styrene copolymer, acrylonitrile-acrylic rubber styrene copolymer, acrylonitrile-ethyelenpropylene rubber-styrene copolymer, high impact polystyrene, and combinations thereof.

The components of the composition can be present within a wide range of amounts. In one particular embodiment, the rubber-modified styrenic copolymer resin is present from about 5 to about 60 parts by weight, the styrenic copolymer resin from about 40 to about 90 parts by weight, and the ethylenic rubber polymer resin from about 0.1 to about 30 parts by weight.

Another aspect of the invention relates to a method of preparing the foregoing polymer composition. This method includes providing the rubber-modified styrenic copolymer resin; providing the ethylenic rubber polymer resin; treating the ethylenic rubber polymer resin with the acidic moiety, in which at least some of the acidic moiety is reacted with the ethylenic rubber polymer resin; and mixing the rubber-modified styrenic copolymer resin with the ethylenic rubber polymer resin to form the polymer composition.

The method can further include other steps, such as extruding the polymer composition, or molding the polymer composition into a shape.

The method can also include providing styrenic copolymer resin, which can reacted with rubber modified styrenic copolymer resin. In some of these embodiments, at least a part of the styrenic copolymer resin is mixed with the rubber-modified styrenic copolymer resin and the ethylenic rubber polymer resin.

Another aspect of the present invention involves a molded article made from the polymer composition described above. A preferred but not necessary attribute of these articles is an impact strength of at least 28 kg·cm/cm, more preferably at least 30 kg·cm/cm, and still more preferably at least 32 kg·cm/cm, when a specimen of the composition is tested according to the standard ASTM D-256 (¼″ notched).

Another preferred though not necessary attribute of the molded article is that the composition has a melt index of at least 1.3 g/10 minute, preferably at least 1.5 g/10 minutes, when a specimen of the composition is tested according to the standard ASTM D1238 (200° C. and 5 kg).

Yet another preferred but not necessary characteristic of the molded article is that the composition has a Falling ball impact strength of at least 23 J, preferably at least 25 J, and more preferably at least 27 J, when a specimen of the composition is tested according to the standard ASTM D-3763 with a falling weight having a mass of 3.729 kg and a hemispherical diameter of 12.5 mm at a height of 30 cm, wherein the specimen is prepared to be square and have a thickness of 3.2 mm and width of 80 mm.

The polymer composition described above can be used in a method of making a plastic structure. This method includes molding the polymer composition into a desired shape.

An electronic device can be made from the molded article. If the electronic device includes a housing, at least a portion of the housing can be made from the polymer composition of the present invention. One method of making such an electronic device includes providing an electronic circuit; providing a housing substantially enclosing the electronic circuit, the housing comprising a portion that comprises the polymer composition of the present invention.

### DETAILED DESCRIPTION OF THE PREFERRED EMBODIMENT

As noted above, one aspect of this invention relates to a polymer composition. According to various embodiments, the polymer composition comprises a rubber-modified styrenic resin and an ethylenic rubber polymer resin comprising an acidic moiety. Molded articles comprising the polymer composition of the embodiments show enhanced physical or mechanical properties as compared to other compositions less one or more components. The molded articles of the embodiments also demonstrate improved flowability over compositions less one or more components. As will be discussed, the molded articles according to embodiments of the invention have good impact resistance, impact strength, and melt index, while maintaining excellent thermal stability.

In one embodiment, the molded article comprises the polymer composition comprising a rubber-modified styrenic copolymer resin and an ethylenic rubber polymer resin comprising an acidic moiety. The polymer composition of the present invention can contain one or more compounds or polymers in addition to the foregoing components. Additional components or additives may be added to provide additional properties or characteristics to the molding composition or to modify existing properties of the composition. For example, an inorganic filler such as glass fiber, carbon fiber, talk, silica, mica, and alumina may be added to improve mechanical strength and heat distortion temperature of the resin composition. In addition, the polymer composition may further include a heat stabilizer, an anti-oxidant, an ultraviolet absorbing agent, a light stabilizer, a flame retardant, a lubricant, a pigment and/or dye. One of ordinary skill in the art will appreciate that various additives may be added to the polymer compositions according to embodiments of the invention.

Certain preferred embodiments of the present invention have an enhanced impact strength of at least about 28 kg·cm/cm, more preferably at least about 30 kg·cm/cm, and even more preferably at least about 32 kg·cm/cm, when a specimen of the composition is tested according to the standard ASTM D256 (¼″ notched) at 23° C.

Another preferred feature of the molded article produced in accordance with the present invention is that it has a melt index of at least 1.3 g/10 minutes when a specimen of the composition is tested according to the standard ASTM D-1238 (200° C. and 5 kg). Furthermore, some embodiments have a melt index of at least 1.5 g/10 minutes when a specimen of the composition is tested according to the standard ASTM D-1238 (200° C. and 5 kg).

Still another preferred feature of the present invention is that it has a falling ball impact strength of at least 23 J, more preferably at least about 25 J, and even more preferably at least about 27 J, when a specimen of the composition is tested according to the standard ASTM D-3763 with a falling weight have a mass of 3.729 kg and a hemispherical diameter of 12.5 mm at a height of 30 cm, wherein the specimen is prepared to be square having a thickness of 3.2 mm and a width of 80 mm.

The polymer compositions can be prepared by mixing their components including a rubber-modified styrenic resin and an ethylenic rubber polymer resin comprising an acidic moiety. In some embodiments, one or more other additives may be mixed together with the components of the polymer composition. One or more component resins can be heated to melt prior to the mixing or the composition may be heated during the mixing. However, the mixing can occur when each components is in a solid, liquid, or dissolved state, or mixtures thereof. In one embodiment, the above components are mixed together all at once. Alternatively, one or more components are added individually. For example, the rubber modified styrenic resin may first be mixed with an ethylenic rubber polymer resin comprising an acidic moiety, prior to mixing this admixture with the remaining components. Formulating and mixing the components may be made by any method known to those persons having ordinary skill in the art, or those methods that may be later discovered. The mixing may occur in a pre-mixing state in a device such as a ribbon blender, followed by further mixing in a Henschel mixer, Banbury mixer, a single screw extruder, a twin screw extruder, a multi screw extruder, or a cokneader.

A molded article can be made using the polymer composition according to the foregoing embodiments. The polymer compositions are molded into various shapes. For polymer with the composition, an extrusion molding machine such as a vented extruder may be used. The polymer composition of embodiments may be molded into various moldings using, for example, a melt-molding device. In embodiments, the polymer composition is formed into a pellet, which then may be molded into various shapes using, for example, injection molding, injection compression molding, extrusion molding, blow molding, pressing, vacuum forming or foaming. In one embodiment, the polymer composition can be made into a pellet using melt-kneading, and the resulting pellets are molded into moldings through injection molding or injection compression molding.

As noted, in one embodiment, the polymer compositions are formed into pellets. In other embodiments, the polymer compositions are formed into structural parts of various consumer products, including electronic devices and appliances. In some embodiments, the polymer compositions are molded into a housing or body of electronic or non-electronic devices. Examples of electrical devices in which a molded article made of the blend of the composition according to embodiments of the invention include printers, computers, word processors, keyboards, personal digital assistants (PDA), telephones, mobile phones, facsimile machines, copy machines, electronic cash registers (ECR), desk-top electronic calculators, PDAs, cards, stationery holders, washing machines, refrigerators, vacuum cleaners, microwave ovens, lighting equipment, irons, TV, VTR, DVD players, video cameras, radio cassette recorders, tape recorders, mini disc players, CD players, speakers, liquid crystal displays, MP3 players, and electric or electronic parts and telecommunication equipment, such as connectors, relays, condensers, switches, printed circuit boards materials, coil bobbins, semiconductor sealing materials, electric wires, cables, transformers, deflecting yokes, distribution boards, clocks, watches, and the like.

Another embodiment provides an electronic device which includes a housing or a part, which is made of a polymer composition comprising a rubber-modified styrenic resin and an ethylenic rubber polymer resin comprising an acidic moiety.

Rubber-Modified Styrenic Copolymer Resin

In certain embodiments, the polymer composition comprises a rubber-modified styrenic graft copolymer resin. This type of resin comprises a rubber and a styrenic graft copolymer. Preferably, the rubber has an average particle size from about 0.1 to about 4 μm. Examples of the rubber include, but are not limited to diene rubbers, such as polybutadiene, and poly(styrene-butadiene), poly(acrylonitrile-butadiene), saturated rubbers having hydrogen added to the diene rubbers, isoprene rubbers, acrylic rubbers, such as polybutylacrylic acid, and ethylene-propylene-diene monomer terpolymers.

In one embodiment, the styrenic copolymer resin may be a styrene-acrylonitrile (SAN) graft copolymer resin. In some embodiments, acrylonitrile (or derivatives thereof) monomers are graft polymerized onto a styrenic polymer. In some, about 5 to about 60% by weight of the acrylonitrile monomers are polymerized onto the styrenic polymer. The remaining acrylonitrile monomers may form another polymer matrix or be a part of their own monomer and/or polymer resin.

The rubber and styrenic graft copolymer resin may be grafted together. In some embodiments, the preferred graft ratio is about 35 to about 90%. In some embodiments, the rubber-modified styrenic graft copolymer resin comprises the rubber from about 30 to about 80% by weight and the styrenic graft copolymer resin from about 20 to about 70% by weight.

In embodiments, the polymer composition comprises the rubber-modified styrenic copolymer resin from about 5 to about 60 parts by weight, based on the total of the rubber-modified styrenic graft copolymer resin, the styrenic copolymer resin, and the olefin copolymer treated with maleic acid being 100 parts by weight. In some embodiments, the rubber modified styrenic copolymer resin is about 5, 8, 11, 14, 17, 18, 20, 22, 25, 28, 31, 33, 35, 38, 42, 45, 47, 49, 51, 53, 55, 57, 59, or 60 parts by weight, or can range from about any of the foregoing amounts to about any other of the foregoing amounts.

Ethylenic Rubber Polymer Resin

In certain embodiments, the ethylenic rubber copolymer resin can be a copolymer of at least two olefin/ethylenic monomers. Many examples of such copolymers can be used. However, as certain specific examples of these embodiments, the olefin copolymer can be a copolymer of ethylene and propylene, or a copolymer of a vinyl monomer and a diene, such as a non-conjugated diene. The olefin copolymer can also be a copolymer of ethylene and/or propylene, and a diene compound.

In some embodiments, the diene may be a non-conjugated diene. Examples of non-conjugated dienes include, but are not limited to, allenes such as 1,2-hexadiene and 1,2 butadiene; 1,4 hexadiene; dicyclopentadiene; and 5-ethylidene-2-norbornene.

The synthesis of olefin copolymers is well known in the art. In some embodiments, the olefin copolymer may be prepared by a solution process using a Ziegler-Natta catalyst. In some embodiments, one or more olefin monomers may each comprise about 30 to about 70% by weight of the total olefin copolymer. Some of these embodiments may optionally include at least one bifunctional vinyl compound, such as a diene, from about 0.1 to about 30 weight percent. The total of the olefin monomers and the optional diene is 100 parts by weight of the olefin copolymer resin.

In certain preferred embodiments, the ethylenic rubber copolymer resin is treated with an acidic moiety. The acidic moiety can be generated in any of a number of ways known to those having ordinary skill in the art. However, in some embodiments, this acidic moiety originates from a polyfunctional organic acid. Examples of such polyfunctional organic acids include, but are not limited to, maleic acid, fumaric acid, citraconic acid, itaconic acid, glutaconic acid, phthalic acid, isophthalic acid, terephthalic acid, tetrahydrophthalic anhydride, cyclohexane dicarboxylic acid, succinic acid, adipic acid, sebacic acid, azelaic acid, malonic acid and alkenyl succinic acids. In certain embodiments, the acidic moiety is an unsaturated dicarboxylic acid such as phthalic acid, terephthalic acid, maleic acid, citraconic acid and so forth. In some of the embodiments of the invention, phthalic acid and/or maleic acid are used. These can be used singly or as a mixture of two kinds or more.

The polyfunctional organic acids can form anhydride ring structures that are also suitable for treatment of the ethylenic rubber to form acid moieties thereon. A large number of derivatives of the anhydrides can also be produced, notably including, but not limited to, -imide forms and alkenyl succinic anhydride derivatives. These derivatives can also serve as useful sources for treatment of the ethylenic rubber to form acid moieties thereon. Thus, when an acidic moiety is said to be originated from a particular organic polyfunctional acid, this includes being originated from any or all of the foregoing derivatives. For example, an acid moiety that originates from maleic acid, may also originate from maleic anhydride, maleimide or any of the derivatives thereof, including alkenyl succinic anhydride derivatives of maleic acid. Similarly, an acid moiety that originates from any other polyfunctional acid, may also originate from its anhydride or any of its derivatives.

In some embodiments, the ethylenic polymer resin is treated by extruding the cohesion improvement agent during the copolymerization to form the olefin copolymer resin. To do so, a conventional catalyst may be added to the mixture, thereby allowing the cohesion improvement agent to react with the olefin monomers and/or diene monomers, and/or the polymers and copolymers thereof. In other embodiments, this process may take after the copolymerization of the olefin monomers and/or the optional diene compounds. In some embodiments, about 0.01 to about 3 parts by weight of the cohesion improvement agent may be used to treat 100 parts by weight of the olefin copolymer resin.

In some embodiment, the olefin copolymer resin treated with a cohesion improvement agent has a melt index of 0.01-40 g/10 minutes in conditions of 230° C. and 10 kg. In other embodiments, the olefin copolymer resin treated with a cohesion improvement agent has a melt index of 8-25 g/10 minutes in conditions of 230° C. and 10 kg.

In embodiments, the polymer composition may comprise the ethylenic rubber polymer resin comprising an acidic moiety, wherein the resin that has been treated is from about 0.1 to about 20 part by weight, based on based on the total of the rubber-modified styrenic graft copolymer resin, the styrenic copolymer resin, and the olefin copolymer treated with a cohesion improvement agent totaling 100 parts by weight. Thus, for example, in some embodiments, the olefin copolymer resin treated with a cohesion improvement agent in about 0.1, 0.2, 0.5, 0.8, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 parts by weight, or can range from about any of the foregoing to about any other of the foregoing figures.

Styrenic Copolymer Resin

In embodiments, the styrenic copolymer resin can be a resin that includes a vinyl aromatic monomer and another monomer. The monomer may depend on compatability with the vinyl aromatic monomer. In certain embodiments, at least part of a styrenic copolymer resin is reacted with the rubber modified styrenic resin to produce an additional shell around the rubber modified styrenic resin. In other embodiments, the styrenic copolymer resin may be an additional component in the polymer composition and dispersed throughout the composition. In some embodiments, at least part of styrenic copolymer resin may be both reacted with the rubber modified styrenic resin and the other part may be dispersed throughout the polymer composition.

Examples of the aromatic vinylic monomer include, but are not limited to, styrene, α-methylstyrene, p-methylstyrene, and so forth.

Examples of the monomer(s) which is (are) polymerized with the aromatic vinyl monomer include, but are not limited to, vinyl cyanide monomers, such as acrylonitrile, and unsaturated nitrile monomers, such as methacrylate.

The aromatic vinyl monomer and other monomer are polymerized together to form the styrenic copolymer resin. The methods of making such copolymers are well known to those skilled in the art. In some embodiments, the styrenic copolymer resin is prepared by copolymerzing about 40% to about 90%, more preferably about 50% to about 80%, by weight of an aromatic vinyl monomer with about 10% to about 60%, more preferably 20% to about 50%, by weight of another suitable monomer.

In some embodiments, the styrenic copolymer resin may further comprise monomers such as acrylic acid, methyacrylic acid, maleic anhydride, or N-substituted maleimide. In some of these embodiments, the additional component is about 0.1 to about 30% by weight, more preferably about 1% to about 10% by weight.

In embodiments, the polymer composition comprises the styrenic copolymer resin from about 40 to about 90 parts by weight, based on the total of the rubber-modified styrenic graft copolymer resin, the styrenic copolymer resin, and the olefin copolymer treated with maleic acid being 100 parts by weight. In some embodiments, the rubber modified styrenic copolymer resin is about 40, 42, 45, 48, 50, 52, 55, 58, 60, 62, 65, 68, 70, 72, 75, 78, 80, 82, 85, 88, and 90 parts by weight.

In some embodiments, the polymer composition or the molded article may additionally contain a flame retardant, a drop-preventing agent, a thermal stabilizer, an antioxidant, a light stabilizer, a compatibilizer, an organic or inorganic pigment, a dye, an inorganic filler, etc. Such additives may be used in an amount of 0-30 parts by weight based on the total weight of the polymer composition or the molded article totaling 100 parts by weight.

In embodiments, a molded article or polymer composition may be prepared by any known method. For example, the inventive composition may be prepared by mixing the components of the compositions and other additives at the same time and melt-extruding the mixture through an extruder so as to prepare pellets. The mixture may also be molded into a predetermined shape and cure to form a molded article.

The invention is further described in terms of the following examples which are intended for the purpose of illustration and not to be construed as in any way limiting the scope of the present invention, which is defined by the claims. In the following examples, all parts and percentage are by weight unless otherwise indicated.

### EXAMPLES

Preparation of the components of the polymer composition. Example 1-6 were prepared in the following fashion:

(A) Rubber-Modified Styrenic Graft Copolymer Resin

To a mixture of 31 parts by weight of styrene, 11 parts by weight of acrylonitrile and 150 parts by weight of deionized water, butadiene rubber latex was added so that the content of butadiene was 58 parts by weight based on the total weight of the monomers. To the mixture, 1.0 part by weight of potassium oleate, 0.4 parts by weight of cumen hydroperoxide, and 0.3 part by weight of a t-dodecyl mercaptan chain transfer agent were added and then allowed to react at a temperature of 75° C. for 5 hours, thus preparing acrylonitrile-butadiene-styrene (ABS) graft latex. To the obtained ABS graft latex, a 1% sulfuric acid solution was added, and the resulting latex was solidified and dried, thus preparing a rubber-modified styrenic graft copolymer resin as powder.

(B) Styrenic Copolymer Resin

To a mixture of 71 parts by weight of styrene, 29 parts by weight of acrylonitrile and 120 parts by weight of deionized water, 0.17 parts by weight of azobisisobutyronitrile, 0.4 parts by weight of a t-dodecyl mercaptan chain transfer agent and 0.5 parts by weight of tricalcium phosphate were added. The resulting mixture was suspension polymerized at 75° C. for 5 hours, thus preparing a styrene-acrylonitrile (SAN) copolymer resin. The copolymer was washed with water, filtered, and dried, thus preparing a SAN polymer resin as powder.

(C) Ethylenic Rubber Copolymer Treated with Maleic Anhydride

Two different ethylenic rubber polymer resin comprising an acidic moiety, and a corresponding resin without an acidic moiety were studied:

(C1) An ethylene-propylene-diene monomer (EPDM) copolymer treated with maleic anhydride, which has a melt index of 10 g/10 minutes in conditions of 230° C. and 10 kg.

(C2) An ethylene-propylene-rubber (EPR) copolymer treated with maleic anhydride, which has a melt index of 20 g/10 minutes in conditions of 230° C. and 10 kg.

(C′) An olefin copolymer resin untreated with a cohesion improvement agent was used, in several Comparative Examples. This olefin copolymer resin was KEP 570P commercially available from Kumho Polychem Co. Ltd., Korea.

(D) Flame Retardant Halogen Based Compound

A flame retardant halogen based compound was also added to several Example and Comparative Examples. This compound was commercially available tetrabromobisphenol A.

(E) Antimony Trioxide

5 parts by weight of antimony trioxide was used in conjunction with the flame retardant halogen based compound (D).

(F) Impact Modifier

In some of the Comparative Examples, a commercially available methacrylate impact modifier (Dupont, Elvaloy 1609) was used.

### EXAMPLES 1-6

The above components were mixed with each other according to the compositions shown in Table 1 below. To the mixtures, 0.2 parts by weight of an antioxidant and 0.02 parts by weight of an impact modifier were added. Then, the resulting mixture was extruded through a conventional twin-screw extruder at a temperature of 200-220° C. so as to prepare pellets.

The prepared pellets were dried at 80° C. for 2 hours and then injected through a 6 oz injector at a polymer temperature of 180-280° C. and a mold temperature of 40-80° C. to manufacture test samples. The test samples were measured for physical properties, and the results are shown in Table 1 below. The unit for the content of each component shown in Table 1 is part by weight.

### COMPARATIVE EXAMPLES 1-6

These samples were manufactured under the same conditions as Examples above except that the samples were compositions of the components as shown in Table 1 below. The prepared samples were measured for physical properties, and the results are shown in Table 1 below.

TABLE I

| | | Examples | | | | | | Comparative Examples | | | | | |
|---|---|---|---|---|---|---|---|---|---|---|---|---|---|
| | | 1 | 2 | 3 | 4 | 5 | 6 | 1 | 2 | 3 | 4 | 5 | 6 |
| (A) Rubber-modified styrenic | | 31 | 31 | 31 | 31 | 27 | 27 | 32 | 32 | 31 | 27 | 31 | 27 |
| resin | | | | | | | | | | | | | |
| (B) Styrene copolymer resin | | 66 | 66 | 66 | 66 | 58 | 58 | 68 | 68 | 66 | 58 | 66 | 58 |
| (C) Ethylenic rubber | (C1) | 3 | — | 3 | — | 15 | — | — | — | — | — | — | |
| copolymer with acidic | (C2) | — | 3 | — | 3 | — | 15 | — | — | — | — | — | |
| moiety | | | | | | | | | | | | | |

| | | | | | | | | | | | | |
|---|---|---|---|---|---|---|---|---|---|---|---|---|
| (C′) Ethylenic rubber copolymer | — | — | — | — | — | — | — | — | 3 | 15 | — | — |
| without acidic moeity | | | | | | | | | | | | |
| (D) Flame retardant | — | — | 15 | 15 | 15 | 15 | — | 15 | 15 | 15 | 15 | 15 |
| (E) Antimony trioxide | — | — | 5 | 5 | 5 | 5 | — | 5 | 5 | 5 | 5 | 5 |
| (F) Impact modifier | — | — | — | — | — | — | — | — | — | — | 3 | 15 |
| Impact strength (kg · cm/cm) | 33 | 32 | 26 | 26 | 24 | 23 | 28 | 12 | 17 | 14 | 19 | 16 |
| Falling ball impact strength (J) | 27 | 27 | 21 | 21 | 19 | 19 | 23 | 10 | 14 | 11 | 14 | 14 |
| Melt index (200° C., 5 kg) | 1.5 | 1.6 | 11.4 | 11.5 | 9.8 | 10.0 | 1.1 | 10.5 | 6.2 | 5.9 | 8.4 | 8.2 |
| Thermal deformation | 88 | 88 | 76 | 76 | 75 | 75 | 88 | 76 | 73 | 72 | 74 | 74 |
| temperature (° C.) | | | | | | | | | | | | |

The samples manufactured in Examples and Comparative Examples were measured for physical properties according to the ASTM standards after being left to stand at a temperature of 23° C. and a relative humidity of 50% for 48 hours.

Methods for Measurement of Physical Properties

Impact Strength

Impact strength refers to mechanical strength of a sample relating to resistance of certain impacts thereto. The specimens were prepared according to ASTM D-256 (¼″ notched) and measured in “kg·cm/cm.”

Falling Ball Impact Strength

Falling ball impact strength refers to mechanical strength of a sample relating to resistance of certain impacts thereto. In accordance with ASTM-D3763, a falling weight having a weight of 3.729 kg and a hemispherical diameter of 12.5 mm was allowed to fall from a height of 30 cm onto a square sample having a thickness of 3.2 mm and a width of 80 mm, and impact absorption energy up to the time point where a first crack occurred was measured.

Melt Index

Melt index refers to the flowability of the polymer composition during processing. This was tested according to ASTM D1238 (200° C. and 5 kg) and measured in “g/10° C.”

Thermal Deformation Temperature

Thermal deformation temperature refers to the temperature and energy required to deflect a standard sample under a certain load. This was tested at a load of 18.6 kgf according to ASTM D648 and measured in ° C.

As can be seen from the results shown in Table 1 above, the molded article comprising the rubber-modified copolymer resin, the styrenic copolymer resin and the olefin copolymer treated with a cohesion improvement agent, shows good impact resistance and flowability without a reduction in thermal deformation temperature. Also, Comparative Examples 3 and 4 using the untreated ethylenic rubber copolymer are seen to have reduced impact resistance and flowability.

Thus, in some embodiments, the molded article can provide good physical properties when used in the production of electronic products including ultra-large-size thin films. Some embodiments have advantages in that they shows excellent impact resistance and flowability while having a good balance of properties, such as thermal resistance, thermal stability, workability and appearance.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of embodiments herein. Rather, the scope of the present invention is to be interpreted with reference to the claims that follow.

What is claimed is:

1. A polymer composition comprising:
a rubber-modified styrenic copolymer resin; and
an ethylenic rubber polymer resin comprising an acidic moiety.

2. The polymer composition of claim 1, wherein the ethylenic rubber polymer resin comprises a copolymer of at least two ethylenic monomers.

3. The polymer composition of claim 2, wherein at least one of the ethylenic monomers is a diene.

4. The polymer composition of claim 1, wherein the ethylenic rubber polymer comprises a polymer of ethylenepropylenediene monomers (EPDM), ethylenepropylene monomer (EPM), and copolymers thereof.

5. The polymer composition of claim 3, wherein the diene is selected from the group consisting of 1,2-hexadiene, 1,4-hexadiene, butadiene, dicyclopentadiene, 5 ethylidene-2-norbornene, and combinations thereof.

6. The polymer composition of claim 1, wherein the acidic moiety is originated from an organic polyfunctional acid.

7. The polymer composition of claim 6, wherein the acidic moiety is originated from maleic acid or phthalic acid.

8. The polymer composition of claim 1, wherein the ethylenic rubber polymer resin comprises the acidic moiety from about 0.01 to about 3 part by weight, based on 100 parts by weight of the ethylenic rubber copolymer.

9. The polymer composition of claim 1, wherein the rubber modified styrenic copolymer resin comprises a styrenic copolymer resin.

10. The polymer composition of claim 9, wherein the styrenic copolymer resin is an additional layer around the rubber modified styrenic copolymer resin.

11. The polymer composition of claim 9, wherein the rubber-modified stryenic copolymer resin comprises at least one selected from a group consisting of acrylonitrile-butadiene-styrene copolymer, acrylonitrile-acrylic rubber styrene copolymer, acrylonitrile-ethyelenpropylene rubber-styrene copolymer, high impact polystyrene, and combinations thereof.

12. The polymer composition of claim 9, wherein the composition comprises the rubber-modified styrenic copolymer resin from about 5 to about 60 parts by weight, the styrenic copolymer resin from about 40 to about 90 parts by weight, and the ethylenic rubber polymer resin from about 0.1 to about 30 parts by weight.

13. A method of preparing the polymer composition of claim 1 comprising:
providing the rubber-modified styrenic copolymer resin;
providing the ethylenic rubber polymer resin
treating the ethylenic rubber polymer resin with the acidic moiety, wherein at least some of the acidic moiety is reacted with the ethylenic rubber polymer resin;
and mixing the rubber-modified styrenic copolymer resin with the ethylenic rubber polymer resin to form the polymer composition.

14. The method of claim 13, further comprising extruding the polymer composition.

15. The method of claim 13, further comprising molding the polymer composition into a shape.

16. The method of claim 13, further comprising providing a styrenic copolymer resin.

17. The method of claim 16, wherein at least a part of the styrenic copolymer resin is reacted with rubber modified styrenic copolymer resin.

18. The method of claim 16, wherein at least a part of the styrenic copolymer resin is mixed with the rubber-modified styrenic copolymer resin and the ethylenic rubber polymer resin.

19. A molded article comprising the polymer composition of claim 1.

20. The molded article of claim 19, wherein the composition has an impact strength of at least 28 kg cm/cm when a specimen of the composition is tested according to the standard ASTM D-256 (¼″ notched).

21. The molded article of claim 19, wherein the composition has an impact strength of at least 30 kg cm/cm when a specimen of the composition is tested according to the standard ASTM D-256 (¼″ notched).

22. The molded article of claim 19, wherein the composition has an impact strength of at least 32 kg·cm/cm when a specimen of the composition is tested according to the standard ASTM D-256 (¼″ notched).

23. The molded article of claim 19, wherein the composition has a melt index of at least 1.3 g/10 minutes when a specimen of the composition is tested according to the standard ASTM D1238 (200° C. and 5 kg).

24. The molded article of claim 19, wherein the composition has a melt index of at least 1.5 g/10 minutes when a specimen of the composition is tested according to the standard ASTM D1238 (200° C. and 5 kg).

25. The molded article of claim 19, wherein the composition has a Falling ball impact strength of at least 23 J when a specimen of the composition is tested according to the standard ASTM D-3763 with a falling weight having a mass of 3.729 kg and a hemispherical diameter of 12.5 mm at a height of 30 cm, wherein the specimen is prepared to be square and have a thickness of 3.2 mm and width of 80 mm.

26. The molded article of claim 19, wherein the composition has a Falling ball impact strength of at least 25 J when a specimen of the composition is tested according to the standard ASTM D-3763 with a falling weight having a mass of 3.729 kg and a hemispherical diameter of 12.5 mm at a height of 30 cm, wherein the specimen is prepared to be square and have a thickness of 3.2 mm and width of 80 mm.

27. The molded article of claim 19, wherein the composition has a Falling ball impact strength of at least 27 J when a specimen of the composition is tested according to the standard ASTM D-3763 with a falling weight having a mass of 3.729 kg and a hemispherical diameter of 12.5 mm at a height of 30 cm, wherein the specimen is prepared to be square and have a thickness of 3.2 mm and width of 80 mm.

28. An electronic device comprising the molded article of claim 19.

29. A method of making a plastic structure comprising:
providing the polymer composition of claim 1; and
molding the polymer composition into a shape.

30. A method of making an electronic device, the method comprising:
providing an electronic circuit;
providing a housing substantially enclosing the electronic circuit, the housing comprising a portion, which comprises the polymer composition of claim 1.

31. An electronic device comprising a housing, wherein the housing comprises a portion comprising the polymer composition of claim 1.
